(19) United States
(12) Patent Application Publication
(10) Pub. No.: US 2021/0034048 A1
(43) Pub. Date: Feb. 4, 2021

(54) TELEMETRY COMPONENT HEALTH PREDICTION FOR RELIABLE PREDICTIVE MAINTENANCE ANALYTICS

(71) Applicant: Microsoft Technology Licensing, LLC, Redmond, WA (US)

(72) Inventor: Yasin Hajizadeh, Bellevue, WA (US)

(21) Appl. No.: 16/526,695

(22) Filed: Jul. 30, 2019

(51) Int. Cl. G05B 23/02; H04L 29/08; H04L 12/24; G06N 20/00

(52) U.S. Cl. CPC G05B 23/0283; H04L 67/12; H04L 41/064; G05B 2223/06; G06N 20/00; H04Q 2209/47; G05B 2223/04; H04L 41/147

(57) ABSTRACT

A system for reliable preventative maintenance of a device includes a telemetry component health predictor that generates predictive performance statistics for telemetry components performing telemetry collection or telemetry transmission operations for the device. The system further includes a predictive maintenance analytics engine that generates predictive performance statistics for the device based on device telemetry and the predictive performance statistics generated for the telemetry components of the device.

### BACKGROUND

In recent years, machine learning has been utilized as a powerful analytics tool to enable predictive maintenance and improved emergency response systems with complex control systems. For example, machine learning is used, in some extent, to perform predictive maintenance in applications such as aerospace (e.g., airplane control systems), heavy machinery (e.g., construction equipment), energy (e.g., hard-to-access components subject to failure such as those in power transmission lines and oil and gas drilling and production), automobiles, life support systems, and more. One significant shortcoming of existing predictive analytics tools is that these tools are typically unable to identify unreliable device telemetry. In instances where sensors and telemetry pipeline devices provide “bad data” to such models, the models generate maintenance predictions and/or initiate anomaly response actions that are based on the bad data.

### SUMMARY

According to one implementation, a system for predictive maintenance of a device assesses and utilizes analytics pertaining to health of telemetry components (e.g., sensors and gateway devices) when rendering predictive maintenance recommendations for the device. The system includes a telemetry component health predictor stored in memory and executable by one or more processors to generate a predictive performance statistic for a telemetry component that performs telemetry collection or telemetry transmission operations for a device. In one implementation, the predictive performance statistic is based on at least one of identity data and health data for the telemetry component. The system further includes a predictive maintenance analytics engine stored in the memory and executable by the one or more processors to generate a predictive performance statistic for the device based on the predictive performance statistic for the telemetry component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example predictive maintenance analytics system that uses telemetry component health predictions to render predictive performance statistics for a device.

FIG. 2 illustrates another example predictive maintenance analytics system that uses telemetry component health predictions to render predictive performance statistics for a device.

FIG. 3 illustrates example operations for performing predictive maintenance on a device via methods accounting for potential unreliability of device's telemetry components.

FIG. 4 illustrates an example schematic of a processing device suitable for implementing aspects of the disclosed technology.

### DETAILED DESCRIPTION

In some predictive maintenance analytics engines, device sensor data is analyzed to obtain information about pre-failure conditions. For example, a machine learning model may be trained on historical sensor data and failure conditions observed in association with different sensor values. Once trained, the machine learning model is then used to generate predictive performance statistics based on real-time sensor measurements. For example, such a model may be used to predict that an airplane engine component has a 90% likelihood of failure in the next 30 days.

In some scenarios, these machine learning analytics outputs are used to guide logical decisions in automated emergency response systems. For example, a maintenance analytics engine for an aircraft may analyze real-time sensor data to identify some anomaly (e.g., significant imminent risk of engine failure) and then, based on such analysis, issue a command to autonomously initiate a sequence of operations predefined in an emergency response plan for the identified anomaly. In cases where sensor data is unreliable or corrupted, such as due to unforeseen problems in the telemetry pipeline, these predictive maintenance analytics tools may misdiagnose system problems, generate unreliable maintenance recommendations, and/or initiate unnecessary response actions.

The herein disclosed technology improves upon existing device predictive maintenance analytics systems by employing machine learning solution(s) to predict telemetry component health and failure risks within the telemetry pipeline that serves to provide inputs to the analytics engine(s) tasked with predictive maintenance and/or autonomous emergency response for the device. According to one implementation, telemetry component health and failure risks are evaluated using a machine learning solution trained on a database of telemetry component data (e.g., sensor measurements as well as data describing identity and/or health of various sensors and gateway components forming a telemetry pipeline) as well as the associations between such data and historical observed failures of those sensors and/or gateway devices.

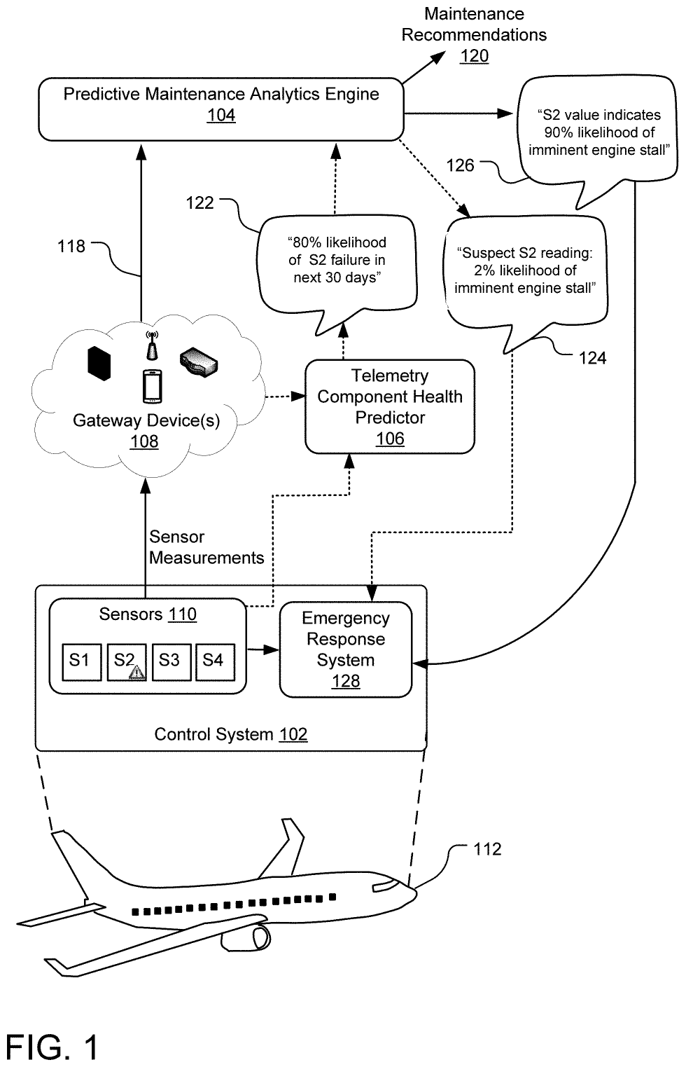

FIG. 1 illustrates an example predictive maintenance analytics system 100 that uses telemetry component health predictions to render predictive performance statistics for a device 112. As used herein, “predictive performance statistic” refers to a prediction associated with the health or performance of a particular component or device, such as a prediction of when a device or component (e.g., machine, server, turbine) will fail or when performance of the component will degrade below some defined threshold. A predictive performance statistic may, for example, include one or more of the following: a predicted failure rate, a probability of failure, a predicted time to failure, or—in cases where the predictive performance statistics pertains to accuracy of a sensor—an uncertainty in a measurement provided by the sensor (e.g., an uncertainty calculation indicating a degree by which a sensor measurement is or is not reliable).

The device 112 is shown to be an airplane but may, in various implementations, be any device that is maintained or operated based on predictive analytics, such as those described herein as rendered by the predictive maintenance analytics engine 104. In one implementation, the device 112 includes one or more processors that implement aspects of a control system 102. In the example of an airplane, the control system may provide the electrical and mechanical controls utilized during nominal and anomalous aviation activities. In an example where the device is a drill rig, the control system 102 may include the electrical and mechanical controls for operating the various aspects of the rig while drilling.

The control system 102 may include a variety of subsystems that collect and/or present data from various sensors 110 of the device (e.g., S1, S2, S3 and S4). In different implementations, the sensors 110 may include a wide variety of sensor types that serve different purposes including without limitation sensors that measure pressure, temperature, voltage, light, (e.g., imaging sensors, proximity sensors), orientation, acceleration, position, etc. The various sensors 110 may include “smart sensors,” “dumb sensors,” or a mix of thereof. In general, the term “smart sensors” is used herein to refer to sensors that include a processor and/or electronics for bidirectionally communicating with other processing entities of the control system 102, gateway device(s) 108, and/or the predictive maintenance analytics engine 104. For example, a smart sensor may be an internet of things (IoT) device that communicates with other processing entities across a wireless network (e.g., Bluetooth, Wi-Fi, or cellular), such as to receive and respond to commands sent from other processing entities.

The predictive maintenance analytics engine 104 includes one or more processors adapted to render predictive performance statistics for the device 112 based on data received from the sensors 110 along a telemetry pipeline 118 that is shown in FIG. 1 to includes one or more gateway devices 108. In general, the term “gateway device” refers to a device that acts as a gateway between two networks, such as a router, firewall, server, etc. A gateway device may provide either an embedded or external gateway with different connectivity options including without limitation Bluetooth, cellular, ethernet, Wi-Fi, etc. In one implementation, all or a portion of the processing operations of the predictive maintenance analytics engine 104 are performed within electronics physically present on the device 112. In another implementation, the predictive maintenance analytics engine 104 is implemented by one or more cloud-based servers.

As used herein, the term “telemetry” is intended to refer to the process by which measurements and other data are collected at remote or inaccessible points and transmitted to receiving equipment for monitoring. Thus, the term “telemetry components” is herein intended to encompass both the sensors that perform the measurements to initially collect data (e.g., the sensors 110) as well as to the various transmission devices (e.g., the gateway devices 108) that convey the data from the point of collection to receiving equipment for monitoring and analysis.

The predictive maintenance analytics engine 104 receives data (measurements) collected by the sensors 110 data along the telemetry pipeline 118 and analyzes the data to render predictive performance statistics pertaining to non-telemetry components of the device 112. As used herein, a “non-telemetry” component is any component or subsystem of the device 112 that does not function to collect or transmit the telemetry that is transmitted along the telemetry pipeline 118. For example, the predictive maintenance analytics engine 104 may render a predictive performance statistic associated with failure of a bracing strut, an engine or engine component, landing gear, etc.

In one implementation, the predictive maintenance analytics engine 104 implements one or more deep learning and/or machine learning models for predictive maintenance including without limitation models that use supervised or unsupervised learning, autoencoders, deep belief network(s), recurrent neural network(s) (LSTMs), convolutional neural networks, restricted Boltzmann machines, consensus self-organizing models (COSMO), etc. For example, one or more of the above models may be utilized to establish parameters of normal operation for the device 112 that may, in turn, be used to formulate rules through condition monitoring during analysis of real-time data from the sensors 110 received along the telemetry pipeline 118. In another implementation, the predictive maintenance analytics engine 104 implements other analytics models that do not utilize machine learning, such as a digital twin model that simulates physics of the device 112 to render predictive analytics (e.g., predictive performance statistics corresponding to one or more non-telemetry components of the device 112).

As mentioned above, the predictive maintenance analytics engine 104 generates predictive performance statistics for the device 112 and its various components. In different implementations, the predictive performance statistics may be used in different ways. In one implementation, the predictive maintenance analytics engine 104 generates maintenance recommendations 120 (e.g., operating recommendations) based on the predictive performance statistics. For example, the predictive maintenance analytics engine 104 may determine that, based on various readings from the sensors 110 (e.g., cabin temperature, accumulated flight time since last servicing), there is a 30% chance that the emergency lighting system within the passenger cabin of the device 112 will fail within 90 days. Based on this, the predictive maintenance analytics engine 104 may recommend servicing and/or replacement of certain lighting components.

In still other implementations, the sensor data is used to generate predictive performance statistics that may serve to trigger real-time response actions, such as to provide real-time information to a device operator or inputs to the control system 102 that may lead to automated remedial actions. For example, an emergency response system 128 of the device 112 may be programmed with response rules conditionally satisfied by predictive performance statistics output by the predictive maintenance analytics engine 104. For example, the predictive maintenance analytics engine 104 may output a predictive performance statistic 126 indicating that a catastrophic system failure is imminent based on one or more observed sensor values that have historically been linked to such failure (E.g., “Sensor 2 (S2) value indicated 90% likelihood of engine stall within next 2 minutes). When reported to the emergency response system 128, this predictive performance statistic may satisfy a rule that causes the emergency response system 128 (or in some cases, the predictive maintenance analytics engine 104) to auto-initiate a predefined sequence of operations to respond to the emergency.

Without a mechanism for determining reliability of the telemetry received at the predictive maintenance analytics engine 104, the generated predictive performance statistics may be prone to significant error which can itself, in cases, lead to catastrophic failure that would not have otherwise occurred. For instance, in 2019 two Boeing 737 aircraft crashed when on-board automated emergency response systems responded to a unreliable predictive performance statistic. Specifically, these two aircraft crashed when a faulty sensor reading indicated aircraft ascension at a higher rate than the actual ascension rate, causing the flight maintenance analytics systems to incorrectly identify a high likelihood of imminent engine stall (e.g., one example predictive performance statistic). The emergency response systems on these two aircraft responded to the faulty predictive performance statistic by repeatedly decreasing the aircraft pitch to prevent engine stall. Since neither aircraft was ascending too steeply to begin with, this decrease in pitch catastrophically caused each of the two aircraft to plummet and crash.

In contrast to the above-described aircraft control systems, the predictive maintenance analytics system 100 of FIG. 1 includes additional technology that allows the predictive maintenance analytics engine 104 to identify when received telemetry is unreliable, thereby providing a means to avoid automated or manual actions predicated on bad data. Specifically, the predictive maintenance analytics engine 104 includes a telemetry component health predictor 106 that performs predictive analytics on the telemetry devices (e.g., the sensors 110 and/or gateway devices 108) and that provides outputs of this analysis to the predictive maintenance analytics engine 104. For clarity of concept, dotted arrows are used to indicate data flows that would not occur if not for the inclusion of the telemetry component health predictor 106 within the predictive maintenance analytics system 100.

The telemetry component health predictor 106 receives various types of data from the sensors 110 and/or gateway devices 108 to render predictive performance statistics for these telemetry components, such as to predict when the sensors 110 and/or gateway device 108 are likely to fail or are no longer supplying reliable data. In addition to or in lieu of the actual measurements collected by the sensors 110, the telemetry component health predictor 106 receives and analyzes sensor data that may include health data and/or identity data pertaining to each of the telemetry devices to render predictive performance statistics for such components.

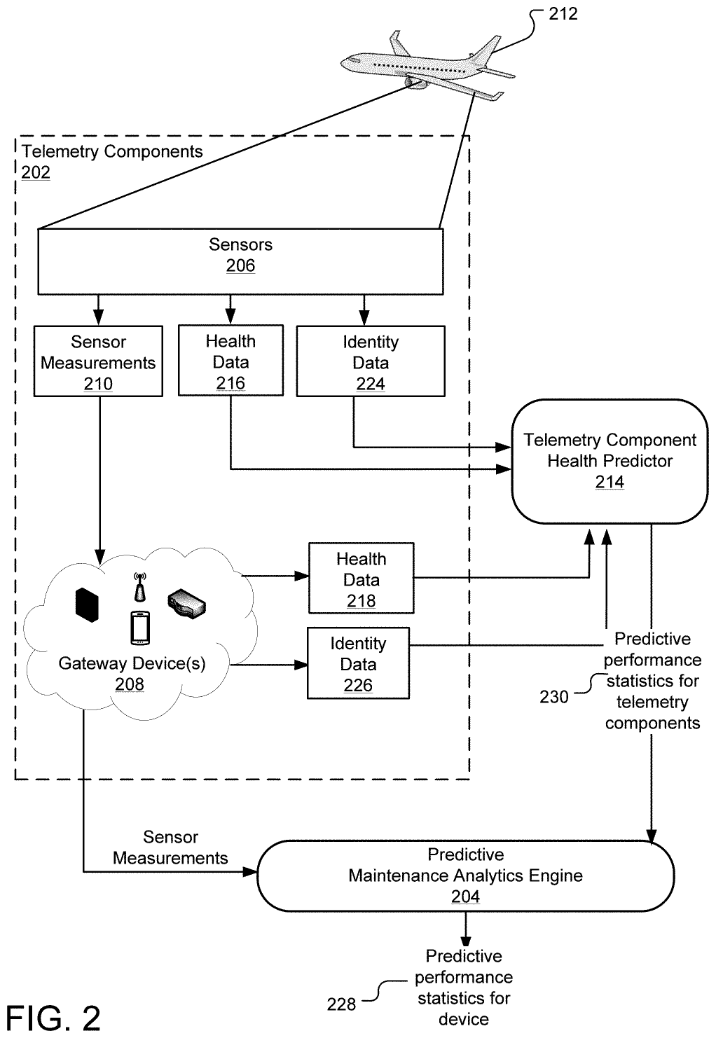

For example, the telemetry component health predictor 106 may receive sensor identity information such as sensor brand, geo-location, time that the sensor has been in operation, or other data that is potentially indicative of sensor health, such as the exemplary health data and identity data discussed further below with respect to FIG. 2. Based on an analysis of the above-described types of data from the telemetry components, the telemetry component health predictor 106 outputs predictive performance statistics for each of the telemetry components including without limitation predictive performance statistics such as failure rate, time to failure, probability of failure, or uncertainty in a sensor measurement. For example, in the example of FIG. 2, the telemetry component health predictor 106 outputs a predictive performance statistic 122 (e.g., “80% likelihood of S2 failure within next 30 days”).

Like the predictive maintenance analytics engine 104, the telemetry component health predictor 106 may implement one or more deep learning and/or machine learning models for predictive maintenance such as deep belief network(s), recurrent neural network(s) (LSTMs), convolutional neural networks, restricted Boltzmann machines, consensus self-organizing models (COSMO), etc. For example, the telemetry component health predictor 106 may implement a machine learning model trained on a training dataset that includes observed failure conditions in association with health and identity data for a variety of different types of telemetry components. Some implementations of the telemetry component health predictor 106 implement other analytics models that do not utilize machine learning solutions.

Outputs of the telemetry component health predictor 106 may be utilized in different ways in different implementations. In one implementation, the telemetry component health predictor 106 provides maintenance recommendations that enable preventative maintenance to be performed on the telemetry components. For example, the telemetry component health predictor 106 may output a maintenance recommendation that recommends replacement or service upon one of the sensors 110 or gateway devices 108 before the components fail. These types of predictive maintenance solutions may be particularly useful in systems where the telemetry components are difficult to access (e.g., an oil well sensor deep underground) or when sensor failure would lead to a significant or dangerous disruption in device operation.

In still other implementations such as that shown in FIG. 1, predictive performance statistics generated by the telemetry component health predictor 106 are input to the predictive maintenance analytics engine 104 and therefore utilized to influence the generation of predictive performance statistics for the device 112 that are output by the predictive maintenance analytics engine 104. For example, the predictive maintenance analytics engine 104 may receive the predictive performance statistic 122 (e.g., the statistic indicating potential sensor failure) and generate an output based on the assumption that the measurements taken by this sensor are unreliable. For example, rather than outputting “90% likelihood of imminent engine stall” the maintenance analytics engine 104 may, in this case, output a predictive performance statistic 124 indicating that the sensor reading is highly suspect and/or that there exists a low probability engine stall: (e.g., “Suspect S2 Reading: 2% likelihood of engine stall”).

The emergency response system 128 may, upon receipt of the predictive performance statistic 124, elect to take no action or take a different action than in the above-described scenario where the emergency response system 128 acted in response to the unreliable predictive performance statistic 126. In this way, the telemetry component health predictor 106 allows for predictive maintenance on telemetry components while also increasing the reliability of predictive maintenance analytics and efficacy of remedial actions based on those analytics.

FIG. 2 illustrates another example predictive maintenance analytics system 200 that uses telemetry component health predictions to render predictive performance statistics for a device 212. The device 212 includes a plurality of telemetry components 202 including sensors 206 coupled to one or more gateway devices 208 across one or more wired or wireless networks. In one implementation, the sensors 206 are physically incorporated within the device 212. The sensors 206 may include any combination of smart sensors and sensors lacking processing capability that collect sensor measurements 210 that are received at and analyzed by a predictive maintenance analytics engine 204. In various implementations, the predictive maintenance analytics engine 204 may be either physically integrated on the device 212 (present within its local computing electronics), entirely cloud-based (e.g., as shown in FIG. 2), or some combination of cloud-based and locally present within the device 212. In implementations where the predictive maintenance analytics engine 204 is implemented on one or more cloud-based servers, the sensor measurements 210 may be transmitted to the predictive maintenance analytics engine 204 along telemetry pipeline 222 using one or more IoT gateway devices 208 to abridge different types of communication networks.

The predictive maintenance analytics engine 204 performs analytics on the sensor measurements 210 to generate predictive performance statistics for the device 212, such as in a manner the same or similar to that described above with respect to FIG. 1. In some implementations, the predictive maintenance analytics engine 204 includes or is in communication with an anomaly response system (not shown) adapted to implement automated actions based on predictive performance statistics generated by the predictive maintenance analytics engine 204.

In addition to the predictive maintenance analytics engine 204, the predictive maintenance analytics system 200 includes a telemetry component health predictor 214 that evaluates the health and performance of the various telemetry components based on various types of sensor data that is either received from the sensors 206 (e.g., as shown) provided by other means, such as by an operator that configures the telemetry component health predictor 214 initially or on an ongoing basis.

The telemetry component health predictor 214 is shown receiving inputs that include health data 216 from the sensors 206 and health data 218 from the gateway device(s) 208. In contrast to the sensor measurements 210 that provide information about the device 212 and its non-telemetry components and operating conditions, telemetry component health data (e.g., the health data 216, 218) provides information about operating conditions of one or more of the telemetry components 202 and that is usable to assess the health and/or reliability of those telemetry components.

Although some basic telemetry components may lack processing electronics for self-collecting health data, a variety of the sensors 206 and the gateway devices 208 may self-record and/or transmit health data to other processing entities. Health data may, for example, include data such as CPU usage, uptime (e.g., time elapsed since last reboot), memory (RAM) usage, data describing the environmental conditions internal to the telemetry component (e.g., temperature, pressure, and voltage sensors included to measure conditions within telemetry component rather than of some external component of the device 212).

In addition to receiving the health data 216, 218 from the telemetry components 202, the telemetry component health predictor 214 may also receive identity data 224, 226 from the sensors 206 and/or gateway devices 208. As used herein, “identity data” refers to information describing a device's identity, origin, or current or past physical locations. For example, identity data may include the particular brand of a telemetry component, the manufacturing year of a telemetry component, or other information about the supply chain along which the telemetry component traveled before being integrated within the device 212. Identity data may also include the current physical location (e.g., latitude/longitude) of the telemetry component.

Although smart sensors and gateway device may be capable of self-collecting, storing, and/or transmitting identity data, the telemetry component health predictor 214 may also obtain identity data for the telemetry components 202 from sources external to the telemetry components 202, such as from the device 212, online databases or manuals (e.g., a database storing serial numbers for different devices in association with identity data for the components included within each device with each different serial number), or from a system operator that initially configures the telemetry component health predictor 214 to render predictive performance statistics for the device 212.

In one implementation, the telemetry component health predictor 214 implements a machine learning model, such as a supervised or unsupervised learning model that generates predictive performance statistics for the telemetry components based on a large training dataset including health and/or identity data for associated with observed failure conditions for different types of telemetry components. For example, the training dataset for the telemetry component health predictor 214 includes health and/or identity data for multiple sensors of the same sensor type (e.g., same make, model) as those included on the device 212 as well as predictive performance statistics in association with those sensors. Likewise, the training dataset may include health and/or identity data for multiple different gateways devices that correspond in type (e.g., make/model) to those gateway device 208 included within the telemetry pipeline 222 for the device 212.

The model implemented by the telemetry component health predictor 214 renders predictive performance statistics 230 for the various telemetry components 202 based on the health and/or identity data for such components that is either statically obtained (e.g., via an initial configuration step), or on an on-going or real-time basis, such as throughout real-time operations of the device 212. For example, the telemetry component health predictor 214 may predict a probability of failure for each of the various individual telemetry components 202 within an associated time window (e.g., an predicted time to failure) or otherwise indicate a degree of uncertainty in the reliability of a particular one of the sensor measurements 210. In some cases, the predictive performance statistics 230 for the telemetry components 202 may, in some implementations, be further used (e.g., by the telemetry component health predictor other processing entity) to render maintenance recommendations when the predictive performance statistics 230 for the telemetry components 202 satisfy defined unreliability criteria. For example, the telemetry component health predictor 214 may provide recommendations to replace or repair individual telemetry components 202 in order to preclude system disruptions due to the failure and/or degradation of such components.

In addition to being used to generate preventative maintenance recommendations, the predictive performance statistics 230 may also be input to the predictive maintenance analytics engine 204 along with the sensor measurements 210, allowing the predictive maintenance analytics engine 204 to generate predictive performance statistics 228 for the device 212 that account for potential unreliability of data received from the telemetry components 202, such as in the manner described above with respect to FIG. 1.

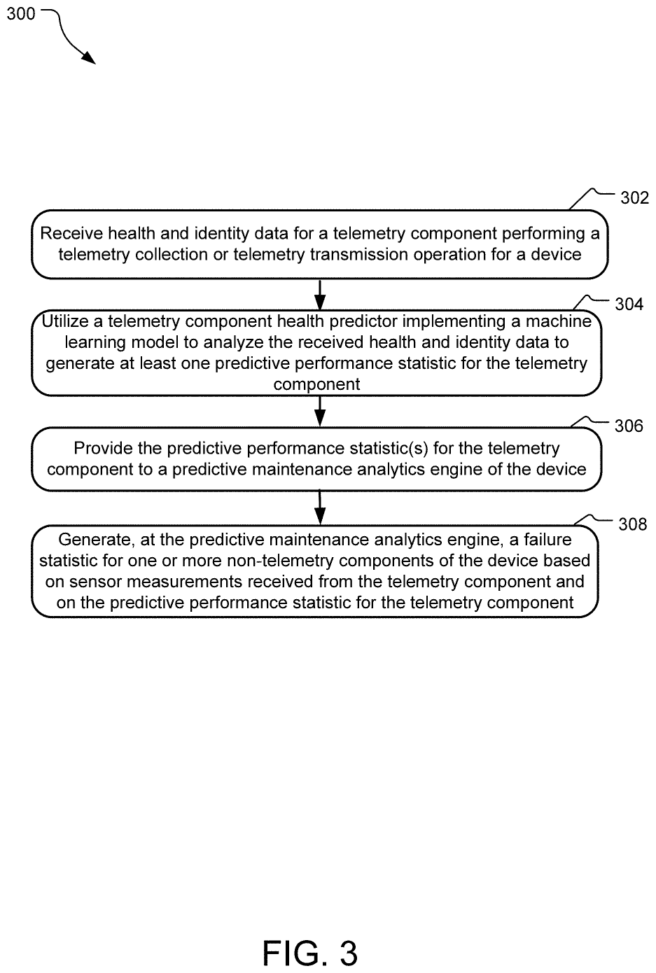

FIG. 3 illustrates example operations 300 for performing predictive maintenance on a device via methods that account for potential unreliability of one or more telemetry components of the device. A receiving operation 302 receives health and identity data for a telemetry component (e.g., a sensor or gateway device) that performs a telemetry collection or transmission operation on behalf of a device. An analysis operation 304 utilizes telemetry component health predictor implementing a machine learning model to analyze the received health and identity data for the telemetry component in view of historically-observed failure conditions for telemetry components of the same type (e.g., make, model). Based on this information, the telemetry component health predictor generates a predictive performance statistic for the telemetry component. For example, the predictive performance statistic may indicate an estimated time to failure or an uncertainty in the reliability of telemetry received from a telemetry component.

A provisioning operation 306 provides the predictive performance statistic for the telemetry component to a predictive maintenance analytics engine designed to provide maintenance recommendations for the device and/or to initiate manual or automated remedial system actions, such as by transmitting outputs to an emergency response system for the device.

A generation operation 308 generates a predictive performance statistic for the device (e.g., either for the device as a whole or for one or more of the device's non-telemetry components) based on both sensor measurements received from the telemetry component and also based on the predictive performance statistic for the telemetry component generated by the telemetry component health predictor.

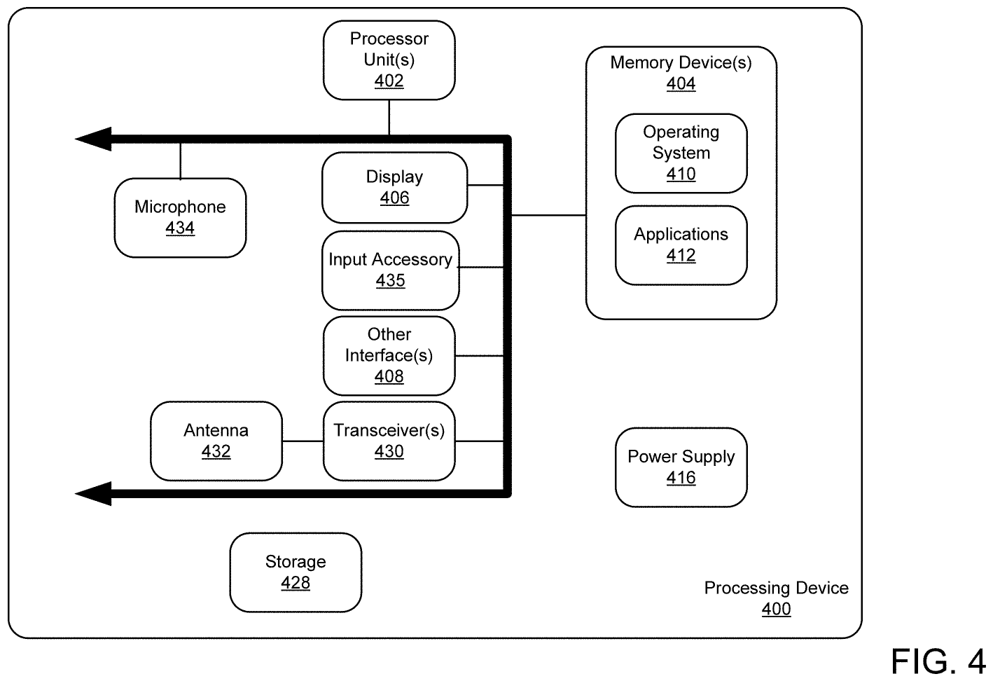

FIG. 4 illustrates an example schematic of a processing device 400 suitable for implementing aspects of the disclosed technology. The processing device 400 includes one or more processor unit(s) 402, memory 404, a display 406, and other interfaces 408 (e.g., buttons). The memory 404 generally includes both volatile memory (e.g., RAM) and non-volatile memory (e.g., flash memory). An operating system 410, such as the Microsoft Windows® operating system, the Microsoft Windows® Phone operating system or a specific operating system designed for a gaming device, resides in the memory 404 and is executed by the processor unit(s) 402, although it should be understood that other operating systems may be employed.

One or more applications 412, such as a predictive maintenance analytics engine (e.g., the predictive maintenance analytics engine 104 of FIG. 1) or a telemetry component health predictor (e.g., telemetry component health predictor 106 of FIG. 1) are loaded in the memory 404 and executed on the operating system 410 by the processor unit(s) 402. The applications 412 may receive input from various input devices such as a microphone 434 or input accessory 435 (e.g., keypad, mouse, stylus, touchpad, gamepad, racing wheel, joystick). The processing device 400 includes a power supply 416, which is powered by one or more batteries or other power sources and which provides power to other components of the processing device 400. The power supply 416 may also be connected to an external power source that overrides or recharges the built-in batteries or other power sources.

The processing device 400 includes one or more communication transceivers 430 and an antenna 432 to provide network connectivity (e.g., a mobile phone network, Wi-Fi®, Bluetooth®). The processing device 400 may also include various other components, such as a positioning system (e.g., a global positioning satellite transceiver), one or more accelerometers, one or more cameras, an audio interface (e.g., a microphone 434, an audio amplifier and speaker and/or audio jack), and storage devices 428. Other configurations may also be employed.

In an example implementation, a mobile operating system, various applications (e.g., telemetry component health predictor 106 and predictive maintenance analytics engine 104, as shown in FIG. 1 above) and other modules and services may have hardware and/or software embodied by instructions stored in memory 404 and/or storage devices 428 and processed by the processor unit(s) 402. The memory 404 may be memory of host device or of an accessory that couples to a host.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example system for predictive maintenance of a device includes a telemetry component health predictor stored in memory and executable by one or more processors to generate a predictive performance statistic for a telemetry component based on either identity data and/or health data for the telemetry component, the telemetry component being a component that performs telemetry collection or telemetry transmission operations for the device. The system further includes a predictive maintenance analytics engine stored in the memory and executable by the one or more processors to generate a predictive performance statistic for the device that is based on the predictive performance statistic for the telemetry component.

In another example system according to any preceding system, the predictive maintenance analytics engine utilizes the predictive performance statistic for the telemetry component to assess reliability of inputs from one or more sensors of the device.

In yet still another example system according to any preceding system, the predictive maintenance analytics engine is adapted to recommend replacement or repair of the telemetry component when the predictive performance statistic from the telemetry component satisfies predefined criteria.

In still another example system of any preceding system, the telemetry component health predictor is further executable to output a maintenance recommendation for the telemetry component.

In yet still another example system of any preceding system, the telemetry component health predictor includes a machine learning model trained on observed failure conditions in connection with at least one of health data and identity data for a plurality of telemetry components of a same component type as the telemetry component.

In still another example system of any preceding system, the telemetry component is at least one of a sensor of the device and a gateway that transmits data between the device and a cloud-based network.

In yet still another example system of any preceding system, the telemetry component is a sensor of the device and the predictive performance statistic output by the telemetry component health predictor indicates an uncertainty in a measurement collected by the sensor.

In yet another example system of any preceding system, the predictive performance statistic output by the telemetry component health predictor includes at least one of a probability of failure for the telemetry component and a predicted time to failure for the telemetry component.

An example method for predictive maintenance of a device includes generating, with one or more processors, a predictive performance statistic for a telemetry component adapted to perform telemetry collection or telemetry transmission operations of the device. The predictive performance statistic is based on at least one of identity data and health data for the telemetry component. The method further includes generating, with the one or more processors, a predictive performance statistic for the device based on the predictive performance statistic for the telemetry component.

According to another example method of any preceding method, the telemetry component is a device sensor and the predictive performance statistic indicates a calculated uncertainty in a measurement of the device sensor. The method further comprises receiving the predictive performance statistic for the device sensor; providing the predictive performance statistic as an input to a predictive maintenance analytics engine implementing a machine learning model to generate predictive performance statistics for the device based on historical device sensor measurements; and generating the predictive performance statistic for the device based on both the historical device sensor measurements and the calculated uncertainty in the measurement.

According to another example method of any preceding method, the predictive performance statistic for the device sensor is generated by a telemetry component health predictor implementing a machine learning model that is trained on a training set including observed failure conditions in association with at least one of health data and identity data for a plurality of components of a same component type as the telemetry component.

According to still yet another example method of any preceding method, the method further entails providing, with the one or more processors, a maintenance recommendation for the telemetry component when the predictive performance statistic from the telemetry component satisfies predefined criteria.

According to still yet another example method of any preceding method, the telemetry component is at least one of a sensor of the device and a gateway that transmits data between the device and a cloud-based network.

According to still yet another example method of any preceding method, the telemetry component is a sensor of the device and the predictive performance statistic for the telemetry component indicates a calculated uncertainty in a measurement collected by the sensor.

According to still another example method of any preceding method, the predictive performance statistic for the telemetry component includes at least one of a probability of failure for the telemetry component and a predicted time to failure for the telemetry component.

An example memory device disclosed herein encodes computer-executable instructions for implementing a computer process comprising: generating, with one or more processors, a predictive performance statistic for a telemetry component based on at least one of identity data and health data for the telemetry component, the telemetry component adapted to perform telemetry collection or telemetry transmission operations of a device; and generating, with the one or more processors, a predictive performance statistic for the device based on the predictive performance statistic for the telemetry component.

In another example computer process encoded on a memory device of any preceding memory device, the computer process generates a predictive performance statistic for a device sensor and generating the predictive performance statistic for the device further comprises: receiving the predictive performance statistic for the device sensor, providing the predictive performance statistic as an input to a predictive maintenance analytics engine implementing a machine learning model to generate predictive performance statistics for the device based on historical device sensor measurements; and generating the predictive performance statistic for the device based on both the historical device sensor measurements and the predicted performance statistic.

In still yet another example computer process encoded on a memory device of any preceding memory device, the predictive performance statistic for the device sensor is generated by a machine learning model that is trained on a training set including observed failure conditions associated with at least one of health data and identity data for plurality of components of a same component type as the telemetry component.

In still yet another example computer process encoded on a memory device of any preceding memory device, the predictive performance statistic for the telemetry component includes at least one of a probability of failure for the telemetry component and a predicted time to failure for the telemetry component.

In still yet another example computer process encoded on a memory device of any preceding memory device, the telemetry component is a sensor of the device and the predictive performance statistic for the telemetry component indicates a calculated uncertainty in a measurement collected by the sensor.

An example system disclosed herein includes a means for generating a predictive performance statistic for a telemetry component based on at least one of identity data and health data for the telemetry component. The telemetry component is adapted to perform telemetry collection or telemetry transmission operations of the device. The system further includes a means for generating a predictive performance statistic for the device based on the predictive performance statistic for the telemetry component.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A system for predictive maintenance of a device, the system comprising:
a telemetry component health predictor stored in memory and executable by one or more processors to generate a predictive performance statistic for a telemetry component that performs telemetry collection or telemetry transmission operations for the device, the generated predictive performance statistic being based on at least one of identity data and health data for the telemetry component; and
a predictive maintenance analytics engine stored in the memory and executable by the one or more processors to generate a predictive performance statistic for the device that is based on the predictive performance statistic for the telemetry component.

2. The system of claim 1, wherein the predictive maintenance analytics engine utilizes the predictive performance statistic for the telemetry component to assess reliability of inputs from one or more sensors of the device.

3. The system of claim 1, wherein the predictive maintenance analytics engine is adapted to recommend replacement or repair of the telemetry component when the predictive performance statistic from the telemetry component satisfies predefined criteria.

4. The system of claim 1, wherein the telemetry component health predictor is further executable to output a maintenance recommendation for the telemetry component.

5. The system of claim 1, wherein the telemetry component health predictor includes a machine learning model trained on observed failure conditions in association with at least one of health data and identity data for each of a plurality of telemetry components of a same component type as the telemetry component.

6. The system of claim 1, wherein the telemetry component is at least one of a sensor of the device and a gateway that transmits data between the device and a cloud-based network.

7. The system of claim 1, wherein the telemetry component is a sensor of the device and the predictive performance statistic output by the telemetry component health predictor indicates an uncertainty in a measurement collected by the sensor.

8. The system of claim 1, wherein the predictive performance statistic output by the telemetry component health predictor includes at least one of a probability of failure for the telemetry component and a predicted time to failure for the telemetry component.

9. A method for predictive maintenance of a device comprising:
generating, with one or more processors, a predictive performance statistic for a telemetry component based on at least one of identity data and health data for the telemetry component, the telemetry component adapted to perform telemetry collection or telemetry transmission operations of the device; and
generating, with the one or more processors, a predictive performance statistic for the device based on the predictive performance statistic for the telemetry component.

10. The method of claim 9, wherein the telemetry component is a device sensor and generating the predictive performance statistic for the device further comprises:
receiving the predictive performance statistic for the device sensor, the predictive performance statistic indicating a calculated uncertainty in a measurement of the device sensor;
providing the predictive performance statistic as an input to a predictive maintenance analytics engine implementing a machine learning model to generate predictive performance statistics for the device based on historical device sensor measurements; and
generating the predictive performance statistic for the device based on both the historical device sensor measurements and the calculated uncertainty in the measurement.

11. The method of claim 10, wherein the predictive performance statistic for the device sensor is generated by a telemetry component health predictor implementing a machine learning model that is trained on a training set including observed failure conditions associated with at least one of health data and identity data for a plurality of components of a same component type as the telemetry component.

12. The method of claim 9, further comprising:
providing, with the one or more processors, a maintenance recommendation for the telemetry component when the predictive performance statistic from the telemetry component satisfies predefined criteria.

13. The method of claim 9, wherein the telemetry component is at least one of a sensor of the device and a gateway that transmits data between the device and a cloud-based network.

14. The method of claim 9, wherein the telemetry component is a sensor of the device and the predictive performance statistic for the telemetry component indicates a calculated uncertainty in a measurement collected by the sensor.

15. The method of claim 9, wherein the predictive performance statistic for the telemetry component includes at least one of a probability of failure for the telemetry component and a predicted time to failure for the telemetry component.

16. One or more memory devices encoding computer-executable instructions for implementing a computer process comprising:
generating, with one or more processors, a predictive performance statistic for a telemetry component based on at least one of identity data and health data for the telemetry component, the telemetry component adapted to perform telemetry collection or telemetry transmission operations of a device; and
generating, with the one or more processors, a predictive performance statistic for the device based on the predictive performance statistic for the telemetry component.

17. The one or more memory devices of claim 16, wherein the telemetry component is a device sensor and generating the predictive performance statistic for the device further comprises:
receiving the predictive performance statistic for the device sensor, the predictive performance statistic indicating a calculated uncertainty in a measurement of the device sensor;
providing the predictive performance statistic as an input to a predictive maintenance analytics engine implementing a machine learning model to generate predictive performance statistics for the device based on historical device sensor measurements; and
generating the predictive performance statistic for the device based on both the historical device sensor measurements and the calculated uncertainty in the measurement.

18. The one or more memory devices of claim 16, wherein the predictive performance statistic for the device sensor is generated by a machine learning model that is trained on a training set including observed failure conditions associated with at least one of health data and identity data for each of a plurality of components of a same component type as the telemetry component.

19. The one or more memory devices of claim 16, wherein the predictive performance statistic for the telemetry component includes at least one of a probability of failure for the telemetry component and a predicted time to failure for the telemetry component.

20. The one or more memory devices of claim 16, wherein the telemetry component is a sensor of the device and the predictive performance statistic for the telemetry component indicates a calculated uncertainty in a measurement collected by the sensor.
